(19) United States
(12) Patent Application Publication
(10) Pub. No.: US 2023/0125242 A1
(43) Pub. Date: Apr. 27, 2023

(54) ELECTROCHEMICAL Ca(OH)2 AND/OR Mg(OH)2 PRODUCTION FROM INDUSTRIAL WASTES AND Ca/Mg-CONTAINING ROCKS

(71) Applicant: The Regents of the University of California, Oakland, CA (US)

(72) Inventors: Gaurav Sant, Los Angeles, MA (US); Xin Chen, Los Angeles, CA (US); Ross Alexander Arnold, Los Angeles, CA (US); Dante Adam Simonetti, Los Angeles, CA (US); Sara Vallejo Castano, Los Angeles, CA (US); Dale Philip Prentice, Los Angeles, CA (US); David Jassby, Los Angeles, CA (US); Shengcun Ma, Los Angeles, CA (US)

(21) Appl. No.: 17/972,392

(22) Filed: Oct. 24, 2022

Related U.S. Application Data
(60) Provisional application No. 63/271,059, filed on Oct. 22, 2021.

(51) Int. Cl. C25B 1/18; C25B 11/046; C25B 11/034; C25B 15/08

(52) U.S. Cl. CPC C25B 1/18; C25B 11/046; C25B 11/034; C25B 15/083

(57) ABSTRACT

A method of preparing metal hydroxides from industrial wastes or alkaline rocks is provided. The method comprise subjecting a mixture comprising a solvent and a solid substrate to a stimulus in order to leach a metal cation from the solid substrate into the solvent, thereby forming a solution comprising the metal cation in the solvent; and contacting the solution of comprising the metal cation with a cathode, thereby electrolytically precipitating the metal hydroxide from the solution. The stimulus may be chemical, mechanical, or both.

### CROSS-REFERENCE TO RELATED APPLICATIONS

This application claims the benefit of priority to U.S. Provisional Application No. 63/271,059, filed on Oct. 22, 2021, the contents of which are hereby incorporated by reference in their entirety.

### STATEMENT OF GOVERNMENT SUPPORT

This invention was made with government support under Grant Number DE-FE0031705, awarded by the Department of Energy. The government has certain rights in the invention.

### BACKGROUND OF THE INVENTION

Ca(OH)₂ (portlandite) can serve not only as a feedstock in carbonation processing of concrete, but it can also be used as a “CO₂-free” feedstock for traditional silicate cement production. But the production of portlandite is accomplished on an industrial scale by the thermal decomposition and hydration of limestone, resulting in >0.75 ton CO₂/ton Ca(OH)₂ produced.¹ Similarly, conventional brucite (Mg(OH)₂) production requires the decomposition of MgCO₃ to MgO and CO₂. Thus, production of both portlandite and brucite are energy intensive and contribute to significant CO₂ emissions. Accordingly, there is a need for more energy efficient processes for producing metal hydroxides such as Ca(OH)₂ and (Mg(OH)₂).

### SUMMARY

The present disclosure relates to methods for producing hydroxide solids, from solid substrates, such as industrial waste or rocks. In some embodiments, the present disclosure provides a method of preparing a metal hydroxide, the method comprising:
subjecting a mixture comprising a solvent and a solid substrate to a stimulus in order to leach a metal cation from the solid substrate into the solvent, thereby forming a solution comprising the metal cation in the solvent; and
contacting the solution comprising the metal cation with a cathode, thereby electrolytically precipitating the metal hydroxide from the solution;
wherein the stimulus is a chemical stimulus, a mechanical stimulus, or both.

In some embodiments, the chemical stimulus is an acid. For example, the acid may be HNO₃, HCl, or HClO₄, or a combination thereof. In some embodiments, the solvent has a pH of less than 6. In preferred embodiments, the solvent has a pH of about 0 to about 3. In some embodiments, the step of electrolytically precipitating the metal hydroxide regenerates the acid.

In some embodiments, the mechanical stimulus is sonication. In more particular embodiments, the sonication is applied with a sonic horn, a somic probe, or a sonic plate. The frequency of the sonication may be in a range of about 2 Hz to about 2 MHz.

In preferred embodiments, the solvent is water.

In some embodiments, the solvent comprises a salt, such as NO₃, NaCl, NaClO₄, or any combination thereof.

In some embodiments, the metal cation is a divalent metal cation, such as Ba(II), Ca(II), Cd(II), Co(II), Cu(II), Fe(II), Mg(II), Mn(II), Mo(II), Ni(II), Sr(II), Zn(II), Zr(II), or any combination thereof. In more preferred embodiments, the divalent metal cation is Ca(II), Mg(II), or a combination thereof. Preferably, the divalent metal cation is Ca(II).

In some embodiments, the method further comprises concentrating the solution comprising the metal cation, thereby increasing the concentration of the metal cation. In some embodiments, concentrating the solution is achieved using reverse osmosis (RO), nanofiltration (NF), electro-separation, or a combination thereof.

In certain embodiments, the method is carried out at a temperature of about 100° C. or less.

In some embodiments, the solid substrate comprises industrial waste, alkaline rock, or a combination thereof. In particular embodiments, the industrial waste comprises slag, fly ash, or a combination thereof.

In some embodiments, the surface may comprise a metallic composition, non-metallic composition, or hybrid metallic and non-metallic composition. More particularly, the electroactive surface may comprise stainless steel, titanium oxide, carbon nanotubes, one or more polymers, graphite, or combinations thereof. In preferred embodiments, the mesh cathode comprises stainless steel.

In some embodiments, the electroactive surface comprises a mesh comprising pores having a diameter in the range of about 0.1 nm to about 10000 μm.

In certain embodiments, the cathode is a rotating disc cathode.

In some embodiments, the method further comprises removing the one or more hydroxide solids from the surface of cathode. In more particular embodiments, the removing the one or more hydroxide solids from the surface of the cathode comprises scraping the surface of the cathode. In even more particular embodiments, the removing the one or more hydroxide solids from the surface of the cathode comprises rotating the rotating disc cathode past a scraper.

### BRIEF DESCRIPTION OF THE DRAWINGS

FIG. 1. Is a schematic of electrolytic Ca(OH)₂ or Mg(OH)₂ production from industrial wastes and Ca-containing rocks. Sonic stimuli are used to directly affect, with or without acid treatment, and control Ca/Mg-extraction, and Ca(OH)₂ and/or Mg(OH)₂ precipitation can be attained via reverse osmosis (RO) and/or nanofiltration (NF) and electrolytic processes.

FIG. 2 Is a graph showing cathode surface pH with respect to hydrogen evolution overpotential, indicating a preferential surface precipitation of Ca(OH)₂ and/or Mg(OH)₂ can be attained. The inset shows Ca(OH)₂ crystals precipitated at the cathode (stainless steel mesh) surface by electrolyzing a 100 mM NaNO₃+100 mM Ca(NO₃)₂ solution.

FIG. 3 Is a schematic illustration of a multi-compartment electrolytic reactor for metal hydroxide (e.g., Ca(OH)₂ or Mg(OH)₂) production, in accordance with the proposed scheme of FIG. 1.

### DETAILED DESCRIPTION

The present disclosure provides methods for production of metal hydroxides, such as calcium hydroxide and magnesium hydroxide, from industrial waste sources and alkaline rocks.

Industrial alkaline wastes and abundant mineral species are precursors that possess large quantities of valuable metal elements, including alkaline earth metals (e.g., beryllium, magnesium, calcium), and/or transition metals (e.g., cobalt, cadmium, nickel, copper, platinum, gold, silver). These precursors, however, rarely bear only one element. For example, steel slags and fly ashes may include significant amounts of calcium, iron, and/or magnesium. Aqueous solutions leached from these precursors (e.g., steel slag and/or fly ash) may contain several metallic and/or semi-metallic species in solution. Each species may include one or more metals that are useful for different applications and, thus, sequential removal of each species at high purity is desirable. The present disclosure provides a system and process combining sonic stimulation, acid dissolution, and, optionally, membrane filtration, to leach metals from precursor solids, followed electrolytic precipitation steps to obtain metal hydroxides. In some embodiments, the metal hydroxide is a hydroxide of is Ba(II), Ca(II), Cd(II), Co(II), Cu(II), Fe(II), Mg(II), Mn(II), Mo(II), Ni(II), Sr(II), Zn(II), Zr(II), or any combination thereof. In more particular embodiments, the metal hydroxide is a hydroxide of Ca(II), Mg(II), or both. Preferably the metal hydroxide is calcium hydroxide. Methods disclosed herein advantageously use sonic stimulation along with acid stimulation of a mixture having a solid substrate and a solvent to extract divalent metal cations into a solution, followed by electrolysis to cause the metal hydroxide to precipitate from the solution.

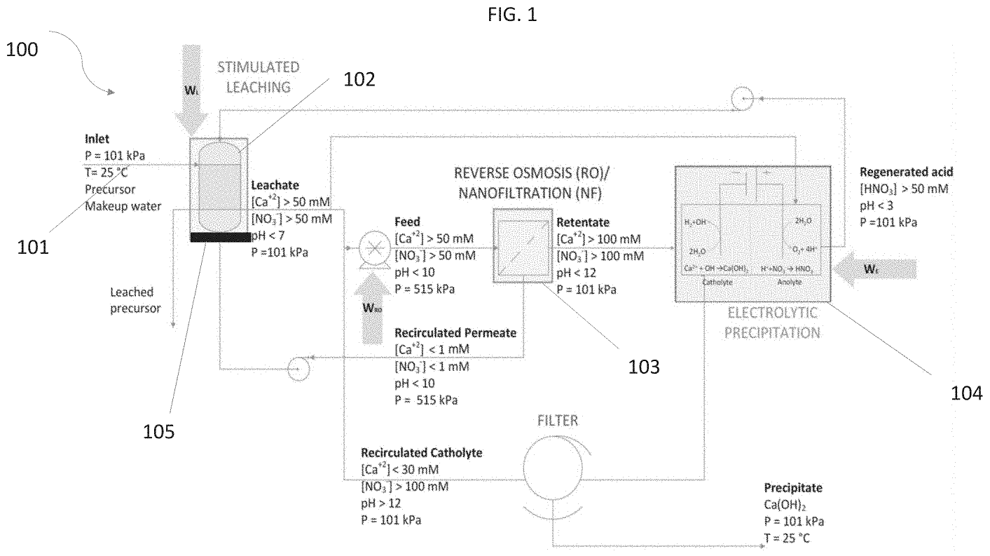

FIG. 1 is a schematic depicting a process according to certain embodiments of the invention. Inlet 101 allows introduction of a solvent and a solid precursor into leaching tank 102 for stimulated leaching. Sonication may be applied to the leaching tank via a sonicator 105 (such as a sonication probe, plate or horn). The stimulated leaching tank may be batch, semi-batch, continuous stirred tank reactor, or a plug flow reactor. Leachate from the tank is introduced to concentration reactor 103 and the resulting retentate provided to electrolysis tank 104 while permeate is returned to the leaching tank. Regenerated acid may flow from the electrolysis tank back to leaching tank 102.

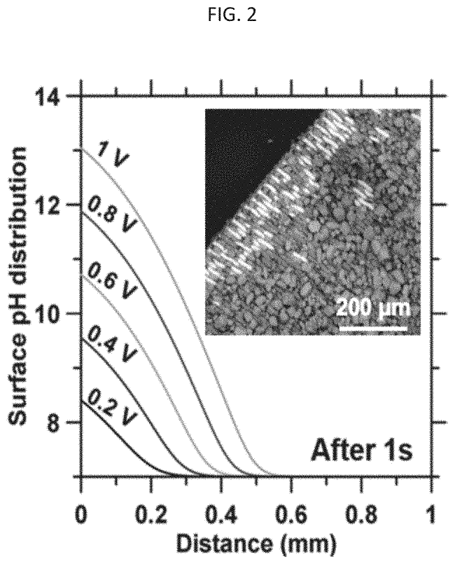

An electrolytic Ca(OH)₂ and/or Mg(OH)₂ precipitation and production process can be achieved thereafter by alkalizing the Ca- and/or Mg-enriched solution (e.g., the retentate from the RO/NF processes). The feasibility of Ca(OH)₂ and/or Mg(OH)₂ precipitation is demonstrated by the simulation of pH at the cathode surface (shown in FIG. 2A). Preliminary electrolytic experiments coupled with geochemical simulation indicate a preferential precipitation of Ca(OH)₂ and/or Mg(OH)₂ can be attained at the high pH region at the surface (i.e., pH >12.5, FIG. 2A and inset).²

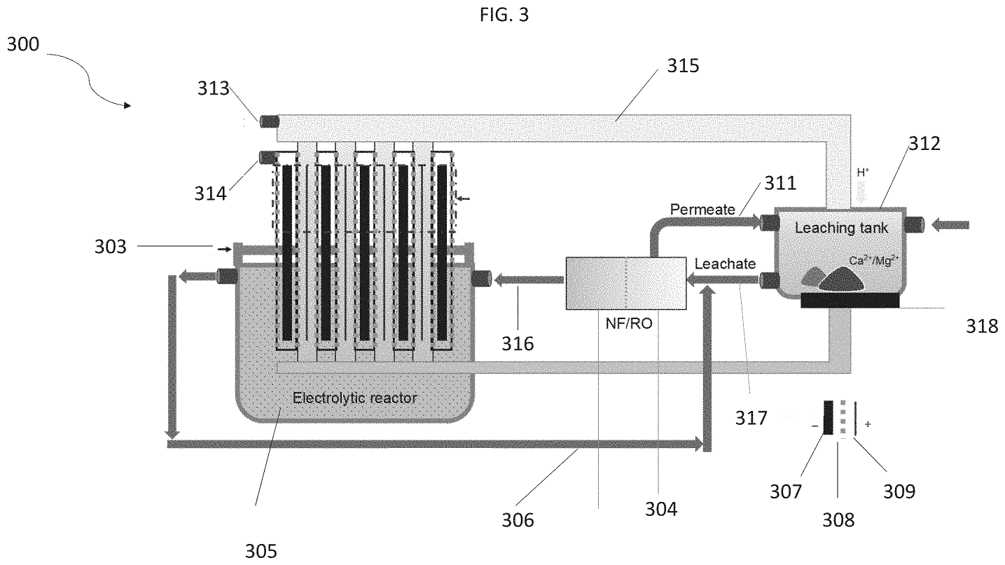

As shown in FIG. 3, an electrolytic reactor schematic 300 is illustrated to conceptualize Ca(OH)₂ and/or Mg(OH)₂ formation in an electrolysis process. The reactor comprises an electrolytic reactor tank 301 having rotating disc/drum cathodes 307 (e.g., stainless steel surface or a mesh) coupled with anodes 309 (e.g., Pt-coated titanium, mixed metal oxides, etc.) to produce alkalinity and acidity. Rotating disc cathode 307 rotates about shaft 303. The reactor further comprises a porous (or semi-porous) barrier 308 used to separate the anolyte from the catholyte. The porous barrier may include asbestos, cellulose, polyvinyl chloride, organic rubber, polyamide, polyolefin, polyethylene, polypropylene, ion exchange membranes, filtration membranes, and any other suitable material, or combinations thereof. The porous barrier separates the catholyte and the anolyte in order to: (1) minimize neutralization reactions between the anolyte and the catholyte, resulting in a stable cathode pH necessary for Ca(OH)₂ precipitation; (2) promote higher energy efficiency of the reactor; and (3) facilitate collection of gas streams (H₂ and O₂). H₂ outlet 314 and O₂ outlet 313 are also depicted. The reactor contains a catholyte and an anolyte where alkalinity and hydrogen, and acidity and oxygen (and possibly other gases) are produced, respectively. The catholyte may be an electrolyte configured to flow around or through the cathode that may comprise a negative charge. The anolyte may be an electrolyte configured to flow around or through the anode, which may comprise a positive charge. The cathodes may be rotated to pass by or through a scraper 310 (e.g., a metallic brush, blade, or high-pressure nozzles) to remove the Ca(OH)₂/Mg(OH)₂, thereby regenerating the cathode for subsequent hydroxide production as the discs rotate back into the tank. In other embodiments, the hydroxide solids may be removed from the catholyte via filtration. The anolyte may then be cycled to the leaching tank 312 via anolyte loop 315, and the produced acidity consumed to dissolve Ca-/Mg-containing alkaline precursors to retain pH-neutrality. Reactor 300 also includes concentrator 304. The catholyte may be circulated to leachate and into the concentrator via catholyte loop 305. Leachate from leaching tank is introduced to the concentrator via leachate outlet 317, where the permeate returns to the leaching tank via permeate out 311, while retentate returns to the reactor tank 305 via retentate outlet 316. Leaching 312 tank may further include a sonicator 318 (such as an ultrasonic probe, plate, or horn).

The energy consumption of the electrolysis step can be estimated based on current state-of-the-art near-commercial electrolyzers operating at 79% efficiency (i.e., 50 kWh of electricity to generate 1 kg of H₂ assuming a thermodynamic demand of 39.4 kWh/kg for the stoichiometric hydrogen evolution reaction: HER).³ The energy demand of the electrolysis step may vary from the thermodynamic minimum of 1.35 MWh/ton to approximately 10 MWh/ton, depending on factors including, but not limited to, the concentration of divalent cation(s) in the inflow to the electrolyzer, applied potential, pH difference between anode and cathode, and Faradaic efficiency. Thus, the electrolysis step is the most energy intensive step of the process. The lowest energy intensity value quoted above produces less CO₂ per ton of Ca(OH)₂ or Mg(OH)₂ than conventional Ca(OH)₂/Mg(OH)₂ production for any electricity source (e.g., coal, natural gas, etc.), whereas the highest energy intensity value produces less CO₂ per ton of Ca(OH)₂/Mg(OH)₂ than conventional Ca(OH)₂/Mg(OH)₂ production for renewable electricity sources (e.g., wind, solar, etc.). Additionally, the process produces 20-40 kg H₂ per ton of Ca(OH)₂/Mg(OH)₂ produced, providing 0.6-1.3 MWh of stored energy.

The present methods advantageously may carried out at relatively low temperatures. For example, the temperature may 100° C. or less for example about 20 to about 100° C., about 25-100° C., about 30-100° C., about 40-100° C., about 50-100° C., about 60-100° C., about 70-100° C., about 80-100° C., about 90-100° C., or any range there between.

In embodiments comprising rotating disc cathodes, inducing the precipitation of the hydroxide solids includes rotating a cylinder consisting of the electroactive mesh in the solution, while applying suction to draw the solution onto the outer surface of the mesh.

In various embodiments, the stimulated dissolution reactor applies sonic energy to the mixture to thereby increase dissolution. Sonic stimulation offers a rapid, low-energy, additive-free route compared to conventional grinding and leaching. In various embodiments, the stimulated dissolution reactor performs ultrasonic stimulation. Ultrasonic stimulation may also be referred to herein as ultrasonication, sonic stimulation, or ultrasonic perturbation. In various embodiments, the stimulated dissolution reactor performs megasonic stimulation. In various embodiments, calcium and/or other metals are extracted from the solid substrate via sonic stimulation at ultrasonic (20-500 kHz) or megasonic (>500 kHz) frequencies in an acidic medium.

In preferred embodiments, the solvent is water. In some embodiments, the chemical stimulus is an acid, such as a mineral acid or an organic acid. In some embodiments, the acid is hydrofluoric acid, hydrochloric acid, hydrobromic acid, hydroiodic acid, boric acid, phosphoric acid, nitric acid, perchloric acid, sulfuric acid, acetic acid, acetylsalicylic acid, carbonic acid, citric acid, and combinations thereof. Preferably, the acid is HNO₃, HCl, or HClO₄, or a combination thereof. In some embodiments, the concentration of the acid in the solvent is up to about 1 mol/L. In some embodiments, the solvent has a pH of less than 6. In preferred embodiments, the solvent has a pH of about 0 to about 3. In some embodiments, the step of electrolytically precipitating the metal hydroxide regenerates the acid.

In some embodiments, the solvent comprises a salt, such as a nitrate, a chloride, a perchlorate, a sulfate, a phosphate, a bromide, a fluoride, a borate, an acetate, a salicylate, a carbonate, a citrate, or any combination thereof. Preferably the salt is a nitrate, a chloride, a perchlorate, or any combination thereof, or any combination thereof. In preferred embodiments, the salt is a sodium salt or a potassium salt. More preferably, the salt is a potassium salt.

In some embodiments, the concentration of acid in the solvent is up to about 1 mol/L. In various embodiments, a pH of the mixture is less than 7, less than 6, less than 5, or less than 4. In more particular embodiments, the pH is about 0 to about 3.

In various embodiments, ultrasonic stimulation is applied to the stimulated dissolution tank. In some embodiments, the frequency range of the acoustic stimulus is about 10 kHz to about 2 MHz. In various embodiments, the ultrasonic frequency is about 18 kHz to about 2000 kHz. In various embodiments, the ultrasonic stimulation frequency is about 20 kHz to about 40 kHz. In various embodiments, the ultrasonic stimulation frequency is about 800 kHz to about 1200 kHz. In various embodiments, the ultrasonic stimulation frequency is greater than or equal to about 18 kHz. In various embodiments, the ultrasonic stimulation frequency is less than or equal to about 2000 kHz. In various embodiments the ultrasonic stimulation frequency is about 20 kHz. In various embodiments the ultrasonic stimulation frequency is about 30 kHz. In various embodiments the ultrasonic stimulation frequency is about 40 kHz. In various embodiments the ultrasonic stimulation frequency is about 50 kHz. In various embodiments the ultrasonic stimulation frequency is about 60 kHz. In various embodiments the ultrasonic stimulation frequency is about 70 kHz. In various embodiments the ultrasonic stimulation frequency is about 80 kHz. In various embodiments the ultrasonic stimulation frequency is about 90 kHz. In various embodiments the ultrasonic stimulation frequency is about 100 kHz. In various embodiments the ultrasonic stimulation frequency is about 200 kHz. In various embodiments the ultrasonic stimulation frequency is about 300 kHz. In various embodiments the ultrasonic stimulation frequency is about 400 kHz. In various embodiments the ultrasonic stimulation frequency is about 500 kHz. In various embodiments the ultrasonic stimulation frequency is about 600 kHz. In various embodiments the ultrasonic stimulation frequency is about 700 kHz. In various embodiments the ultrasonic stimulation frequency is about 800 kHz. In various embodiments the ultrasonic stimulation frequency is about 900 kHz. In various embodiments the ultrasonic stimulation frequency is about 1000 kHz (1 MHz). In various embodiments the ultrasonic stimulation frequency is about 1100 kHz (1.1 MHz). In various embodiments the ultrasonic stimulation frequency is about 1200 kHz (1.2 MHz). In various embodiments the ultrasonic stimulation frequency is about 1300 kHz (1.3 MHz). In various embodiments the ultrasonic stimulation frequency is about 1400 kHz (1.4 MHz). In various embodiments the ultrasonic stimulation frequency is about 1500 kHz (1.5 MHz). In various embodiments the ultrasonic stimulation frequency is about 1600 kHz (1.6 MHz). In various embodiments the ultrasonic stimulation frequency is about 1700 kHz (1.7 MHz). In various embodiments the ultrasonic stimulation frequency is about 1800 kHz (1.8 MHz). In various embodiments the ultrasonic stimulation frequency is about 1900 kHz (1.9 MHz). In various embodiments the ultrasonic stimulation frequency is about 2000 kHz (2 MHz).

In various embodiments, the ultrasonic stimulation is provided by a sonic probe that is at least partially submerged in the solvent-substrate mixture. In various embodiments, the ultrasonic stimulation is provided by one or more ultrasonic plates in contact with the leaching tank. In still further embodiments, the ultrasonic stimulation is provided by both a sonic (e.g., ultrasonic) probe and a sonic (e.g., ultrasonic) plate. In various embodiments, the sonic probe causes agitation of the solvent due to the rapid motion of the probe. In various embodiments, the solvent-substrate mixture may be stirred, mixed, or blended in the leaching tank to ensure thorough mixing of the solvent. In various embodiments, as the solid substrate to-be-leached contains other less-soluble elements (e.g., non-target materials), a portion of the solid substrate remains undissolved, and may be removed as spent solid.

In some embodiments, the solid substrate is industrial waste or by-product, such as those derived from metal processing and fuel combustion (e.g., coal fly ashes), among other sources that are generally enriched in Ca and Mg. In some embodiments, Ca²⁺ and Mg²⁺ are extracted from slags, fly ashes, or other alkaline solids by dissolution in, or exposure to, water or other aqueous leaching solution at ambient or moderately elevated temperature, and at ambient pressure, in the presence or not, of specific leaching aids. Slags, which are by-products derived from metal production, include slags derived from iron production (e.g., air-cooled blast furnace (BF) slag) and steel production (e.g., electric arc furnace (EAF) slag and basic oxygen furnace (BOF) slag), and are typically composed of Ca and Mg oxides, silicates, and silicon dioxide. Although glassy slags find use as replacement material for ordinary Portland cement (OPC), crystalline slags presently find limited use as low-value aggregates. Such crystalline slags are abundant and include significant amounts of Ca and Mg. Fly ash, including that sourced from historical reservoirs (e.g., landfills and ash ponds), is a coal combustion by-product which also includes high concentrations of Ca. In order to increase a leaching rate, one or more metal leaching agents (e.g., acetate, ethylenediaminetetraacetic acid (EDTA), and so forth) and/or one or more acids (e.g., acetic acid, hydrochloric acid, and so forth) can be added to a leaching solution. A slag can also be ground or pulverized to finer particle sizes to increase the rate of light metal extraction.

The solid in some embodiments is fly ash. Fly ash (also referred to as flue ash, coal ash, or pulverized fuel ash is a coal combustion product containing particulates (fine particles of burned fuel) that are driven out of coal-fired boilers together with flue gases. Ash that falls to the bottom of the boiler's combustion chamber (commonly called a firebox) is called bottom ash. In modern coal-fired power plants, fly ash is generally captured by electrostatic precipitators or other particle filtration equipment before the flue gases reach the chimneys. Together with bottom ash removed from the bottom of the boiler, it is known as coal ash.

Depending upon the source and composition of the coal being burned, the components of fly ash vary considerably, but all fly ash includes substantial amounts of silicon dioxide (SiO₂) (both amorphous and crystalline), aluminium oxide (Al₂O₃) and calcium oxide (CaO), the main mineral compounds in coal-bearing rock strata.

In other embodiments, the solid is alkaline rock. Alkaline rocks are generally considered to have more alkalis than can be accommodated by feldspars alone. The excess alkalis then appear in feldspathoids, sodic pyroxenes/amphiboles, or other alkali-rich phases. Alkaline rocks are deficient in SiO₂ with respect to NaO, K₂O, and CaO to the extent that they become critically undersaturated in SiO₂, and nepheline or acmite (Na clinopyroxene).

In various embodiments, larger solid substrates may be ground prior to leaching by first grinding, crushing, or pulverizing the substrate to a particle size of about 10 mm or less, 5 mm or less, 1 mm or less, 0.5 mm or less, or 0.1 mm or less. In various embodiments, the particles may be about 100 μm or greater. In various embodiments, the particles have an average diameter of about 500 nm to 5 mm, about 100 μm to about 5 mm, about 500 μm to about 5 mm, or about 500 μm to about 3 mm.

In various embodiments, the dissolution tank may be operated as a continuous flow reactor. In various embodiments, the dissolution tank may be operated as a batch reactor.

In some embodiments, the solution comprising the metal cation is concentrated before the electrolysis step. In various embodiments, a concentrator performs nanofiltration and/or reverse osmosis. In various embodiments, the membrane concentrator performs filtration. In various embodiments, the membrane concentrator may perform filtration to filter particles that are larger than a predetermined size (e.g., diameter). In various embodiments, the membrane concentrator selectively filters multivalent ions and allows monovalent ions to pass through. In other embodiments, nanofiltration is based on ion charge. In still other embodiments, nanofiltration is based on both ion size and ion charge. In various embodiments, the membrane concentrator outputs a concentrated retentate stream of ionic species (e.g., a concentrated divalent cation stream).

In various embodiments, the anolyte from the electrolysis step is returned to the leaching tank.

In an electrolytic system, reduction occurs at the cathode and oxidation occurs at the anode. The anodic reaction (2H₂O→4H++O₂) advantageously produces the acidity sufficient for elemental extraction in the dissolution tank. At the cathode, the reduction of water (2H₂O→H₂+2OH−) takes place, which releases alkalinity to raise the pH. In various embodiments, metal hydroxides precipitate when the pH exceeds certain values. In various embodiments, CaOH₂ is preferentially produced when pH at the cathode surface is above a pH of about 12 (see FIG. 2).

The terms “approximately,” “about,” “substantially,” and similar terms will be understood by persons of ordinary skill in the art and will vary to some extent depending upon the context in which it is used. If there are uses of the terms that are not clear to persons of ordinary skill in the art, given the context in which it is used, the terms will be plus or minus 10% of the disclosed values. When “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein, the term “comprising” is intended to mean that the compounds, compositions and methods include the recited elements, but not exclude others. “Consisting essentially of” when used to define compounds, compositions and methods, shall mean excluding other elements of any essential significance to the combination. Thus, a composition consisting essentially of the elements as defined herein would not exclude trace contaminants, e.g., from the isolation and purification method and pharmaceutically acceptable carriers, preservatives, and the like. “Consisting of” shall mean excluding more than trace elements of other ingredients. Embodiments defined by each of these transition terms are within the scope of this technology.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

Example 1: The scheme (FIG. 1) describes additive- (i.e., acid- and base-)-free, or additive-containing processing wherein acoustic stimuli are used to directly affect and control the precursor leaching processes. Acoustic stimulation may be added by an ultrasonic horn or ultrasonic plates in a stimulation frequency from 10 kHz to 2 MHz. The acoustic stimulator may be operated in semi-batch, continuous-stirred tank (CSTR), or plug flow (PFR) reactors, with acoustic stimulation applied in situ by a submerged sonotrode, or through the reactor wall(s) by external sonotrode(s). The estimated energy requirement (i.e., W_{L} in FIG. 1) of such stimulated leaching processes is about 10 kWh/ton of Ca(OH)₂ and/or Mg(OH)₂ produced. Salts, such as NaNO₃, NaCl, NaClO₄, etc. can be added during the leaching process to enhance the electric conductivity of the leachate. The leachate, thereafter, will be fed to a concentration reactor that utilizes, but is not limited to, reverse osmosis (RO) and/or nanofiltration (NF) to enrich the Ca²⁺/Mg²⁺ concentration. Experimental data has demonstrated a concentration reactor energy consumption of about 40-80 kWh/ton of Ca(OH)₂/Mg(OH)₂ produced.

While certain embodiments have been illustrated and described, it should be understood that changes and modifications may be made therein in accordance with ordinary skill in the art without departing from the technology in its broader aspects as defined in the following claims.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

### REFERENCES

[1] Environmental Protection Agency. Technical Support Document for the Lime Manufacturing Sector; 2015.
[2] Parkhurst, D. L.; Appelo, C. A. J. Description of Input and Examples for PHREEQC Version 3—A Computer Program for Speciation, Batch-Reaction, One-Dimensional Transport, and Inverse Geochemical Calculations, 2013.
[3] Ivy, J. Summary of Electrolytic Hydrogen Production: Milestone Completion Report; National Renewable Energy Lab., Golden, Colo. (US), 2004.
[4] Portland Cement Association Labor-Energy Input Survey. https://www.cement.org/docs/default-source/market-economics-pdfs/more-reports/labor-energy-sample-2.pdf (accessed 2021 Sep. 3).

Other embodiments are set forth in the following claims.

### INCORPORATION BY REFERENCE

All publications and patents mentioned herein are hereby incorporated by reference in their entirety as if each individual publication or patent was specifically and individually indicated to be incorporated by reference. In case of conflict, the present application, including any definitions herein, will control.

1. A method of preparing a metal hydroxide, the method comprising:
subjecting a mixture comprising a solvent and a solid substrate to a stimulus in order to leach a metal cation from the solid substrate into the solvent, thereby forming a solution comprising the metal cation in the solvent; and
contacting the solution comprising the metal cation with a cathode, thereby electrolytically precipitating the metal hydroxide from the solution;
wherein the stimulus is a chemical stimulus, a mechanical stimulus, or both.

2. The method of claim 1, wherein the chemical stimulus is an acid.

3. The method of claim 2, wherein the acid comprises hydrofluoric acid, hydrochloric acid, hydrobromic acid, hydroiodic acid, boric acid, phosphoric acid, nitric acid, perchloric acid, sulfuric acid, acetic acid, acetylsalicylic acid, carbonic acid, citric acid, and combinations thereof or a combination thereof; preferably hydrochloric acid, nitric acid, perchloric acid, or any combination thereof.

4. The method of claim 2, wherein the solvent has a pH of less than 6.

5. The method of claim 4, wherein the solvent has a pH of 0 to about 3.

6. The method of claim 2, wherein electrolytically precipitating the metal hydroxide regenerates the acid.

7. The method of claim 1, wherein the mechanical stimulus is sonication.

8. The method of claim 7, wherein the sonication is applied via a horn, a probe, or a plate.

9. The method of claim 7, wherein the frequency range of the sonication is in a range of about 2 Hz to about 2 MHz.

10. The method of claim 1, wherein the solvent is water.

11. The method of claim 1, wherein the solvent comprises a salt.

12. The method of claim 11 wherein the salt comprises a nitrate, a chloride, a perchlorate, a sulfate, a phosphate, a bromide, a fluoride, a borate, an acetate, a salicylate, a carbonate, a citrate, any combination thereof, preferably a nitrate, a chloride, a perchlorate, or any combination thereof.

13. The method of claim 1, wherein the metal hydroxide is a divalent metal hydroxide.

14. The method of claim 13, wherein the divalent metal hydroxide is Ba(II), Ca(II), Cd(II), Co(II), Cu(II), Fe(II), Mg(II), Mn(II), Mo(II), Ni(II), Sr(II), Zn(II), Zr(II), or any combination thereof.

15. The method of claim 14, wherein divalent metal cation is Ca(II), Mg(II), or a combination thereof.

16. The method of claim 15, wherein the divalent metal cation is Ca(II).

17. The method of claim 1, further comprising concentrating the solution comprising the metal cation, thereby increasing the concentration of the metal cation in the solution.

18. The method of claim 17, wherein concentrating the solution is achieved by using reverse osmosis (RO) or nanofiltration (NF), electro-separation, or a combination thereof.

19. The method of claim 1, wherein the method is carried out at a temperature of about 100° C. or less.

20. The method of claim 1, wherein the solid substrate comprises industrial waste, alkaline rock, or a combination thereof.

21. The method of claim 20, wherein the industrial waste comprises slag, fly ash, or a combination thereof.

22. The method of claim 1, wherein the cathode comprises an electroactive surface.

23. The method of claim 22, wherein the electroactive active surface comprises a metallic composition, a non-metallic composition, or a combination thereof.

24. The method of claim 23, wherein the electroactive surface comprises stainless steel, titanium oxide, carbon nanotubes, one or more polymers, graphite, or combinations thereof.

25. The method of claim 24, wherein the electroactive surface comprises stainless steel.

26. The method of claim 22, wherein the electroactive surface comprises an electroactive mesh comprising pores having a diameter in the range of about 0.1 nm to about 10000 μm.

27. The method of claim 1, wherein the cathode is a rotating disc cathode.

28. The method of claim 1, further comprising removing the one or more hydroxide solids from the surface of cathode.

29. The method of claim 28, wherein the removing the one or more hydroxide solids from the surface of the cathode comprises scraping the surface of the cathode.

30. The method of claim 29, wherein removing the one or more hydroxide solids from the surface of the cathode comprises rotating the rotating disc cathode past a scraper.
